(19) United States
(12) Patent Application Publication
(10) Pub. No.: US 2025/0278705 A1
(43) Pub. Date: Sep. 4, 2025

(54) METHODOLOGY AND APPLICATION OF ASSEMBLING DEVICES TO UTILIZE THE MIXED-WASTES FOR THE FINANCIAL BENEFITS OF ALL PARTIES INVOLVED

(71) Applicants: Meesue Kim, Kirkland, WA (US); Nam Soo Kim, Incheon (KR); Yoo Seung Kim, Bangkok (TH)

(72) Inventors: Meesue Kim, Kirkland, WA (US); Nam Soo Kim, Incheon (KR); Yoo Seung Kim, Bangkok (TH)

(73) Assignee: Meesue Kim, Kirkland, WA (US)

(21) Appl. No.: 18/056,256

(22) PCT Filed: Nov. 16, 2022
(86) PCT No.: PCT/US2022/079910

§ 371 Date: Nov. 17, 2022

(51) Int. Cl. G06Q 10/30; B65B 31/04; B65B 57/10; B65B 61/02; G06Q 20/20; G06Q 20/38; G06V 20/52

(52) U.S. Cl. CPC G06Q 10/30; B65B 31/04; B65B 57/10; B65B 61/025; G06Q 20/20; G06Q 20/389; G06V 20/52

(57) ABSTRACT

In order to efficiently dispose of and effectively utilize the wastes, one of the main culprits of global warming, it is crucial to introduce waste separation and carbon neutral related waste-treatment technologies. Among the supply & value chains of waste, the proper collection and preparation of raw materials is most important. Developed to remind users that garbage can provide additional income rather than unnecessary burden, this invention introduces the smart treatment of collected wastes, validation of the heating value of the waste through image processing and NIR spectra, and data processing technologies and algorithms to build trust based on block-chain technology amongst all parties involved. By implementing these novel methodologies, algorithms, devices, and data-management related technologies, people are encouraged to actively participate in the efficient treatment and recycling of various wastes, providing a better alternative to the method used today that mainly relies on compulsory control through fines.

### FIELDS

The present invention relates to the fields of Information and Communication Technology (ICT), Industry 4.0, the Municipal Solid Waste (MSW), Payment Systems and Methods, and especially to payment systems and methods deployed in the wastes treatment system.

### BACKGROUND OF THE INVENTION

The United Nations (UN) estimates that approximately 30% of the people in the world live an unhealthy life due to insufficient food intake. The deplorable truth is that 30% of the world's food production in this world has been and is continued to be wasted for various reasons. Food waste induces not only enormous economic losses but also damage the environment. This invention focuses on the methodologies applicable for the treatment of wastes, especially selected food wastes generated from its deliberate disposal by consumers (approximately 40% of food waste is from the average consumer household and around 40% is from the food service industry). The reality of the environmental damage caused by inappropriately treated food waste is way beyond our imagination. Recent research says that the global food loss & waste generates 4.4 GtCO₂ eq (about 8% of total anthropogenic Green House Gas (GHG) emissions) annually¹. The Food and Agriculture Organization (FAO) states that global food waste results in more GHG emissions than does any country in the world except for China and the United States². In their report “Food wastage footprint,” the UN states that more than 1.3 billion tons of food are thrown away, resulting in 3.3 billion tons of carbon dioxide emissions each year. Food waste from landfills and/or streams through sewage systems pollute the water resources mainly due to the large amounts of methane production. An immediate practical methodology of the implementation of the carbon neutral wastes-treatment is presented via this invention. It can be applied to the sites (residential & office area, agricultural area, industrial area, and restaurants area) where the wastes are being generated. Among all types of mixed solid wastes, this patent application selects the food-wastes to explain the general methodologies, technologies, and business models which are applied and the food-wastes which are dumped through sewers has been seriously considered. This unlawful activity can be seen globally by people (such as street vendors) who habitually dump food-wastes into the sewers on the side of the streets, and this activity has been continuously contaminating not only the town where they live but also the environment of this entire planet. Unfortunately, however, it is difficult for relevant authorities to monitor and to restrict them due to several reasons such as the lack of budget and the lack of education. The methodologies applied in this invention introduce solutions to motivate people to participate in the operation presented below, which includes the following:
1. The application of optic sensors (including lens-less cameras), moisture monitoring sensors, and weight measuring sensors that are within the closed space of the devices (wastes sorting & packaging devices) which are distributed to the operators (end-users in edge node) via a practical financial program to get rid of unnecessary burdens for the end-user, and the structuring of the data generated from these sensors via edge computing algorithms for further data analytics in the cloud networks
2. The application of (an) algorithm(s) to transform the image information of the wastes (which are separated and collected for proper packaging) into 2-dimensional (2D) coordination data to (1) minimize the size of the data and (2) extract the data required to be processed via edge-node computing operation
3. The application of (an) algorithm(s) to transform the multiple 2D coordination data from different angles into 3-dimensional (3D) data to reconfirm the detection of any unexpected foreign materials put into the mixed-wastes
4. The application of near infrared (NIR) spectrometer to either the very edge-node devices (waste sorting & vacuum packaging device) or the second edge-node devices (such as the vacuum packaged wastes collecting bin) to generate NIR spectra data to calculate the heating value from the mixed wastes in the vacuum package in a nondestructive way
5. The application of methodologies and data transmittal devices (such as Low Range Wide Area Network (LoRa WAN)) to transmit the data among devices and various type of servers in the system for the purpose of the fair distribution of financial profits to the participants involved (especially the original owner of the wastes)
6. The designing and setting of the conditions of each parameter, which are being generated by the edge-node sensors to get rid of unnecessary noises prior to the structuring of the raw data
7. The structuring of the application of algorithms (especially for image recognition, the transformation of image information into 2D & 3D coordination data, texture related data extraction, etc.) to process the raw data via edge computing operation
8. The application of a novel design for transmitting the data to build up the mutual understanding amongst the parties involved throughout the entire business flow for fair distribution of profits based on the concept of the blockchain technology together with a trusted third-party validation
9. The use of analytic image data & spectra data throughout the entire system of wastes-treatment for deep learning and machine learning purposes to ensure the fair distribution of profit amongst the parties involved
10. The methodology of applying the digital barcode (such as the QR code) to trace and to confirm the economic value of the wastes that must be packaged by the specially designed ubiquitous devices
11. Blockchain based decentralized edge computing algorithms & systems based on the Artificial Intelligence & Internet of Things (AIoT) technologies to ensure the fait distribution of profits from the wastes.

The methodologies and algorithms applied to confirm the economic value of the packaged wastes to build up the mutual understandings amongst the parties involved throughout the entire business flow for fair distribution of the profits occurred by the sales of products & byproducts from the treatment of the packaged wastes are the core components of this novel invention. Not only for the purpose of increasing their income (especially the income for the original owner of the wastes), but also in order to protect the environment from the global warming phenomena, people will participate in the program more aggressively, and, as a result, this invention will contribute to the decrease of carbon emissions globally.

### BRIEF SUMMARY OF THE INVENTION

This invention especially involves data management related engineering as well as technologies in relation to the methodology of wastes treatment (especially mixed food-wastes) based on the applications of AIoT. There will be distributions of specially designed units to the end-users (end-users at the farm in the harvesting site of agricultural and aquacultural crops/commodities, at the warehouse, at the manufacturing site, at the restaurant, at the residential house, and at the office space) for treating their waste (especially, the food-wastes) in an eco-friendly manner. This device will generate basic data that is required to calculate the heating value of the vacuum packaged waste. Therefore, the device will be the first edge-node for all participants to build up and confirm the mutual understandings of the value of the packaged waste amongst those directly involved in the entire business flow. In addition, this invention involves engineering in relation to the application of technologies to sense and/or monitor the conditions of each vacuum packaged waste to figure out the following:
1) The heating value of each package and the purity of the wastes.
2) The value of the products and byproducts (such as synthetic gas, crude oil, and biochar) from the packaged waste.
3) The amount of carbon emission that is cut down by applying the presented invention.

This invention also involves engineering & technologies in relation to the methodology for transmitting the data in optimal and efficient conditions. This methodology includes algorithms that can be applied to be processed in the edge-node computing operation. This operation in the edge-node is critically important to build up the foundation of the mutual understandings between the parties directly involved throughout the entire business flow for the fair distribution of profits from the waste treatment.

### BRIEF DESCRIPTION OF THE SEVERAL VIEWS OF THE DRAWING

The flows in the drawings provided below show the applicable methodology of the utilization of data for its transmittal, analysis, and computation:

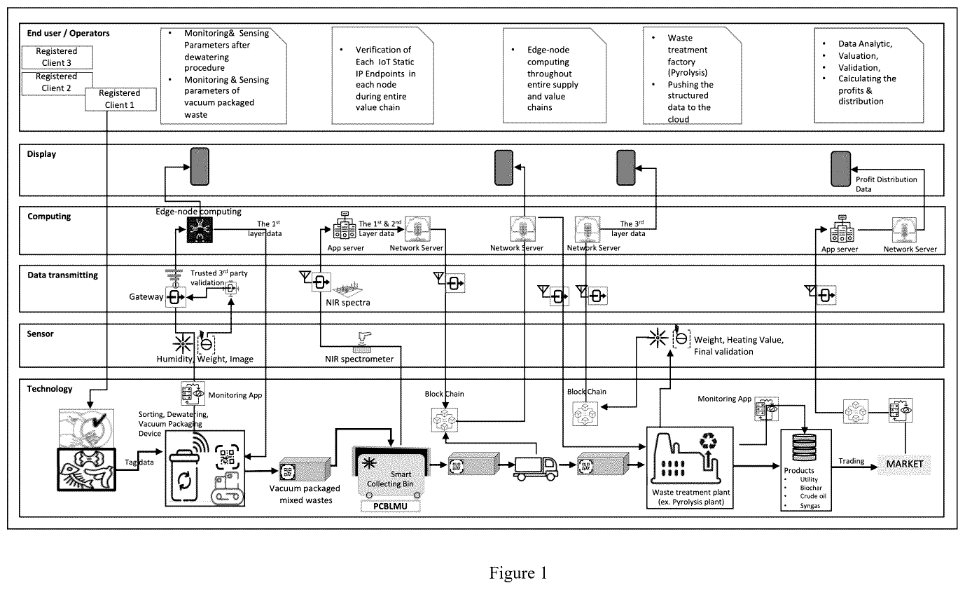

1. FIG. 1: The collection of the registered customer and/or all of the operator's identification related data during the entire process of the treatment of the collected wastes.

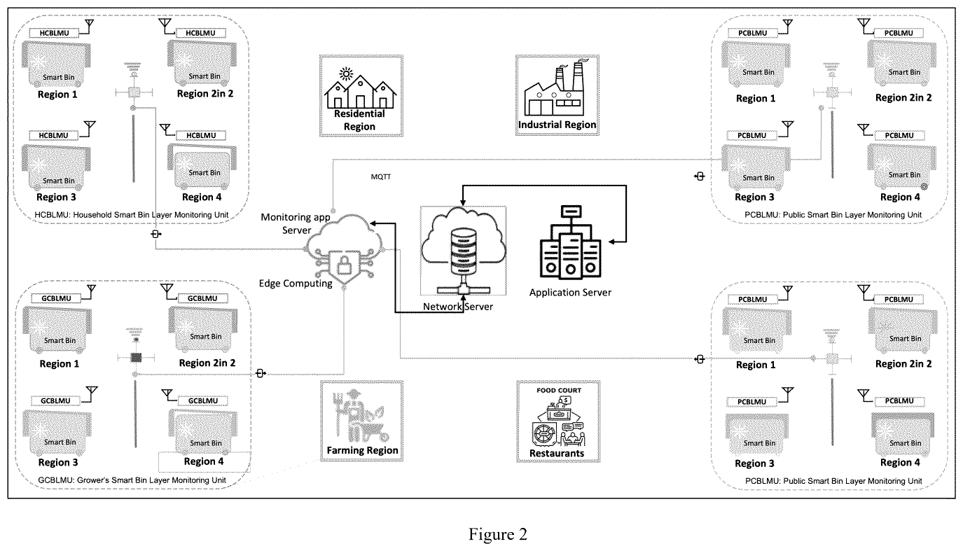

2. FIG. 2: The collection of the heating value related data of each packaged waste from the monitoring devices (sensors) that are equipped to the device(s) distributed to the customer/operator, and then the transmittal of this data back and forth to the servers before and after the application of edge-node computing.

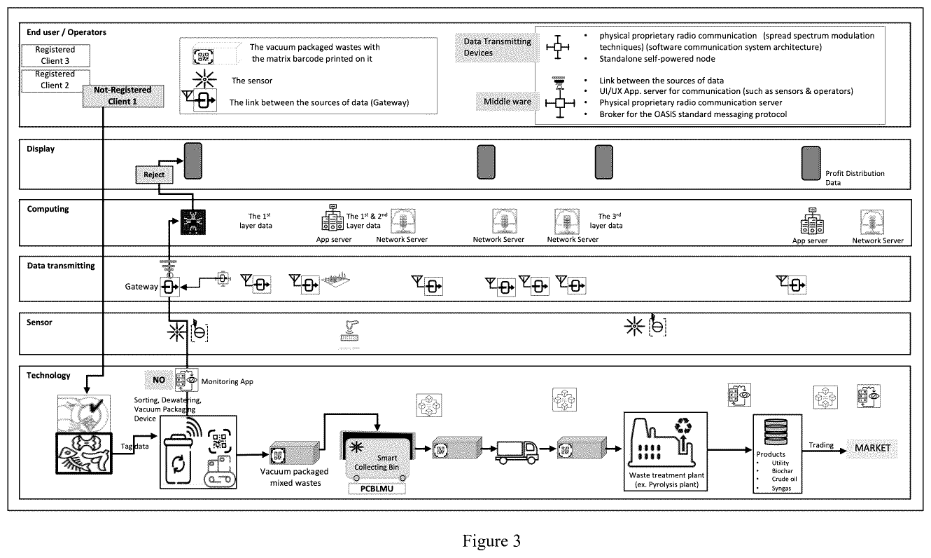

3. FIG. 3: The optic sensor (including lens-less image sensor) used to monitor the feature of the image characteristics of the mixed wastes before it is vacuum packaged. The visual property (especially the visual property that deals with the texture of the wastes is important to confirm and reconfirm the purity of the wastes in the packaging) of the image of the wastes being captured by the optic sensor will be utilized for machine learning. A novel system and related software (algorithms, applications) that comes together with optic sensor and edge-node computing devices which equips the software to ensure the reliability of the methodology applied confirms and reconfirms the financial value of the waste in the packaging. The pattern of information or the arrangement of the structure found from the image captured by the optic sensors are utilized for machine learning and more findings derived from correlations among fundamental parameters that will be utilized for deep learning via Artificial Intelligence based computing processes.

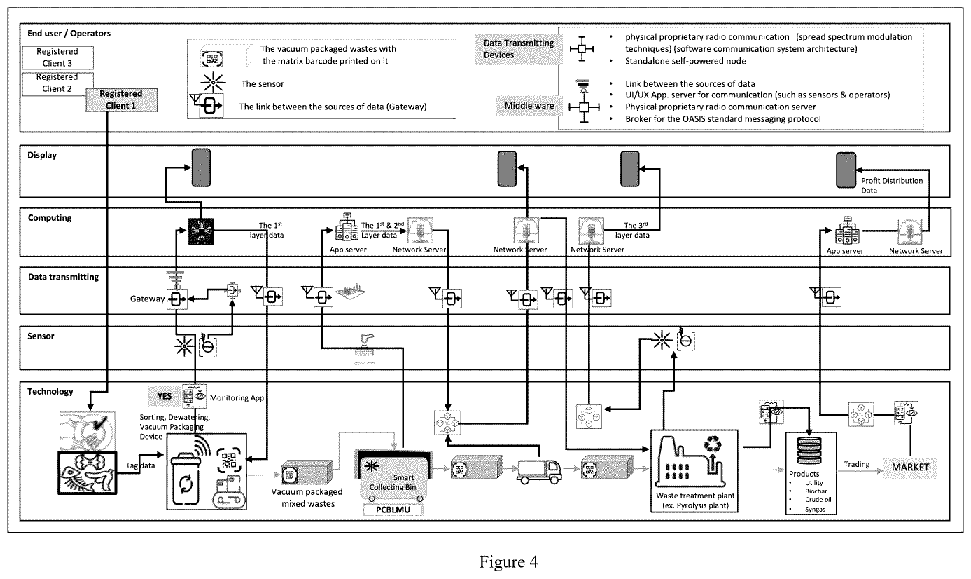

4. FIG. 4: The collection of NIR spectra from the NIR (Near Infrared) Spectrometer from the device(s) being operated at the very edge-node of the business flow (such as vacuum packaging unit) or from the second-end edge node of the business flow (such as the smart collecting bin)

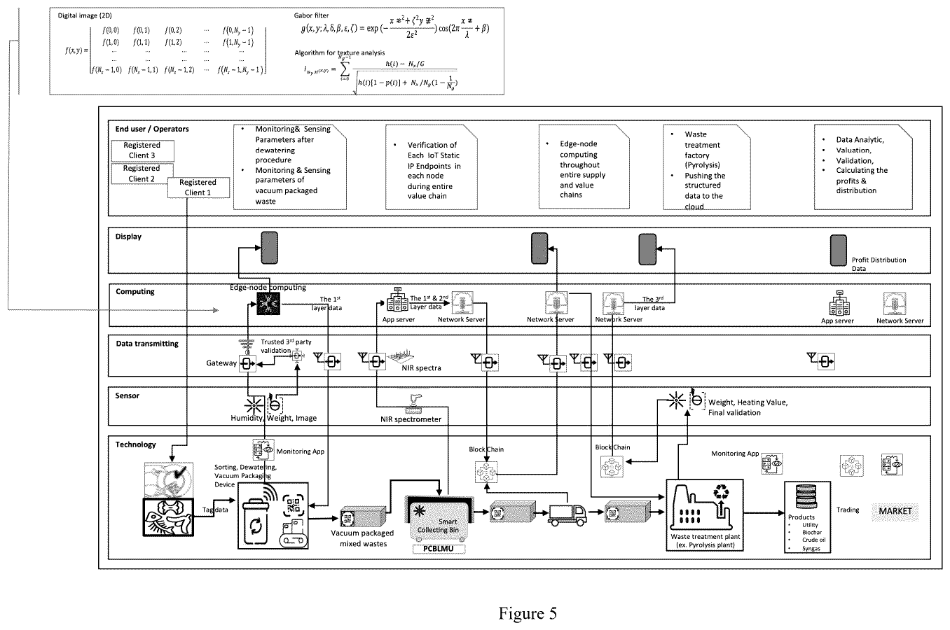

5. FIG. 5: The storing of the fundamental info, such as the processed data as well as the preliminary image analytic data, into random-access memory (RAM) during the operation of edge-node computing operation and/or gateway (concentrator)

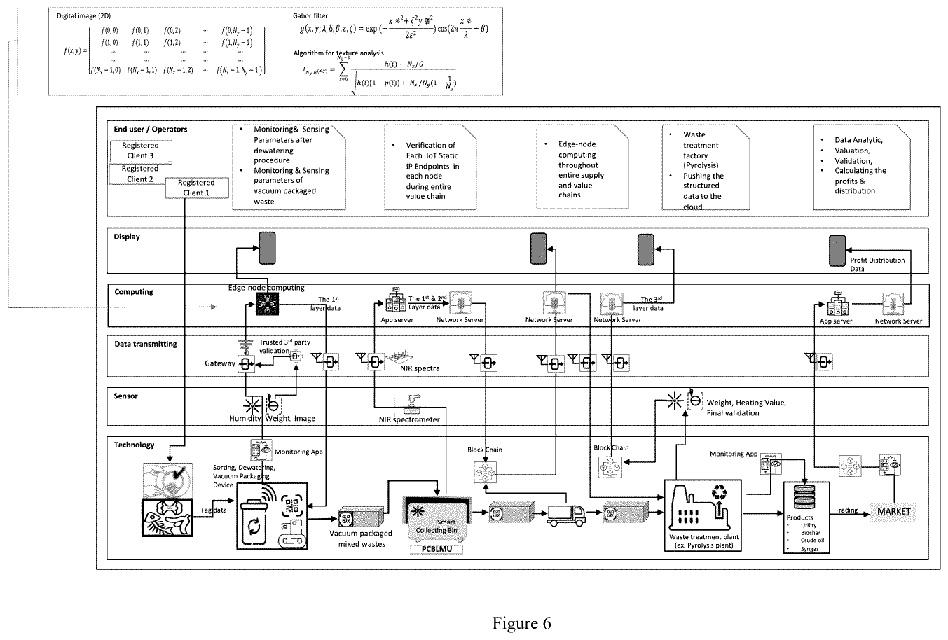

6. FIG. 6: The analysis of the structured data (all the data from each packaged waste throughout entire business flow) using the algorithm engine (Business Rule Engine) to reconfirm the economic value of the wastes and also to finalize the mutual understandings for the fair distribution of the profits via block chain technology.

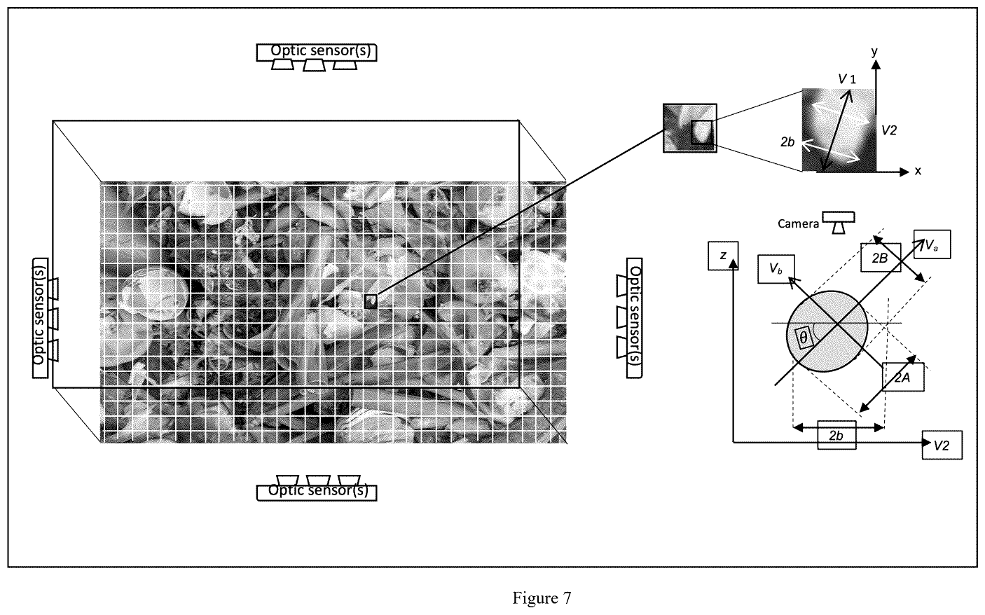

7. FIG. 7: Sample lens view of an oblate object from the mixed wastes collected. The axis “V1” is oriented as the eigenvector. The blue circle is located at the center of mass of the selected portion of mixed wastes.

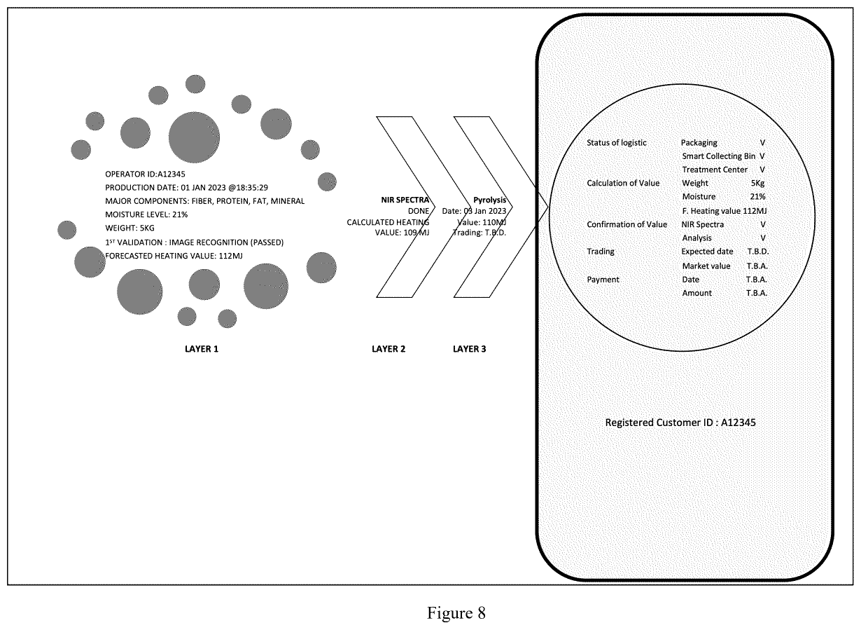

8. FIG. 8: The procedure of data flow and status shown in the display

### MAJOR COMPONENTS

1. The wastes separator used to get more accurate heating values from the mixed wastes
2. The dewatering device
3. The optic sensor and related devices used to collect image data from the collected wastes
4. The image analytic algorithm (extraction and recognition) used to confirm the purity of the wastes in the packaging
5. Moisture meter and scaling meter
6. The vacuum packaging device
7. The device used to generate and print the matrix barcode (such as the QR code)
8. The battery package (optional)
9. The monitoring & validating system (hardware & application software) attached to the vacuum packaged wastes receiving unit (this system focuses on the validation of all data and especially reconfirms the accuracy of the data generated from each packaged wastes)
10. The algorithm, software, and hardware used to convert 2D image information into 2D coordinational matrices and 3D coordinational matrices for image analysis
11. The data transmittal related hardware used to push the data to the gateway/concentrator via the cloud
12. The Smart Collecting Bin (container) which has the ability to communicate with servers via the cloud to reconfirm the reliability of the data
13. The Near Infrared (NIR) Spectrometer attached to the smart collecting bin to generate the spectra
14. An algorithm for deep learning based on the correlation between spectra data and the heating value
15. An algorithm for the Monitoring, Reporting, and Validating (M.R.V.) of carbon emission reduction to cover the financial benefits from the Emission Trading Scheme
16. The payment system related software application for the fair distribution of profits amongst the parties involved based on the algorithm that deals with sales of the byproducts (crude-oil, synthetic gas, and bio-char) from the wastes treatment as well as the resulting carbon credit (amount of carbon emission reduced via the distributed food-waste treatment system)

FIG. 1 shows the basic components of the unit(s) (device) that need to be distributed to the end-users to sort mixed wastes (especially food-wastes). This waste will be vacuum packaged for it to be sent to the Waste Treatment Factory (such as a pyrolysis plant, biomass power-plant, fertilizer producing factory, etc.). The steps are described in the drawing attached. FIG. 1 explains the data flow between each node of operation throughout the entire business flow, and it also shows the foundation of the methodologies applied in the presented invention as follows:
1. The mixed wastes (especially food wastes) are sorted at the edge-node where the collected mixed wastes are started to be screened by sensors (such as optic sensors, weight scaling monitor, moisture monitor) for the first time in the system
2. The device distributed to the end-user/operator receives data from all the sensors equipped in said device to start processing several validation procedures (such as instant image recognition, extracting targeted texture, etcetera)
3. The wastes are then dewatered prior to the procedure of vacuum packaging
4. The heating value of the specific vacuum packaged waste will be calculated in the server, and then all parties involved in the entire business flow will confirm and reconfirm the heating value of the specific packaged wastes.
5. When the operator in the edge-node practice delivers it to the smart collecting bin, the NIR spectroscopy related basic hardware, which is equipped in the collecting bin, will generate the spectra from the vacuum packaged wastes.
6. The spectra will be analyzed via the server to reconfirm the heating value of the packaged waste.

FIG. 2 shows the general workflow that will be applied for monitoring activities (operations) from various sources of wastes being generated in order to collect data, transmit data, and analyze data (including the methodology of sharing data between IoT devices, such as the optic sensor(s) attached to the device and/or the unit and scaling sensor(s) attached to the device and/or unit) among parties involved.

Operations described in FIG. 1 are applicable to various industries/regions such as the residential region, industrial regions, farming regions, and the commercial region (where food-courts are located). The NIR spectroscopy supporting hardware can be utilized to equip to the smart collecting bins for specific types of wastes to reconfirm the heating value. The spectra data being generated by the NIR spectrometer will directly communicate with the servers (especially the application server). For example, the general composition of the mixed wastes being generated from the forest & agricultural farming region are different from the ones from the everyday food-wastes. In this case, the most common components of the mixed wastes from the forest & agricultural farming region will be forest residues and/or agricultural biomasses. Five forest residues (cellulose, hemicelluloses, lignin, ash, and extractive contents) are also easily found from the agricultural biomasses. To get efficient outcomes (heating value based on carbon negative operation), the conversion of these residues (biomasses) into biomass pellets is considered. The vacuum package from the forest/agricultural region will contain humidity-controlled biomass pellets. Therefore, other methodologies instead of NIR spectroscopy will be utilized for second layer validation.

FIG. 3 shows the flow of the transmittal of the heating value-related data of each vacuum packaged waste that is not registered in the system until it arrives at the waste receiving terminal. The flow also shows the applicable methodology of the utilization of data for data analysis.

FIG. 3 shows how the packaged wastes manufactured by the “not registered client” are rejected by the system, while FIG. 4 shows how the normal function is being operated. An incomplete or an inappropriate dataset being generated and operated by a not registered client, which is sent by data transmitting devices to the blockchain algorithm, will be rejected by the monitoring web server. A validation procedure by a trusted third party (TTP) is the key component to not only check if the operation is done by a registered client but also for the traceability of the packaged wastes. FIG. 5 shows the procedure of data flow from the end-user (edge-node) all the way to the application server for existing customers without the recording of the session's information, and FIG. 6 shows the flow of data from the existing customers with the recording of the session's information. Both figures (FIGS. 5 and 6) show the data being generated at the point of the end-user's operation. This data is related to the weight and moisture of the wastes being transmitted to the concentrator/gateway, and this concentrator/generator processes it together with the NIR spectra data being generated from the smart collecting bin. The analyzed structured data being stored in the second layer will be processed via blockchain technology, and this revalidated data will be processed together with data being generated from the waste-treatment factory and transmitted to the cloud-based network server and application server to be processed and calculated by the AI algorithm. The fair distribution of the profits amongst the parties involved in the entire business flow is designed based on the Advanced Encryption Standard (AES) secure payload.

FIG. 4 shows the flow of the transmittal of heating value related basic data of each vacuum packaged wastes that are registered in the system. The flow also shows the applicable methodology of the utilization of data for data analysis.

FIG. 5 shows the flow of the transmittal of heating value related data of each vacuum packaged wastes that are from existing customers (without the recording the session's information) in the system. The flow also shows the applicable methodology of the utilization of data for data analysis.

FIG. 6 shows the flow of the transmittal of heating value related data of each vacuum packaged wastes that are from existing customers (with the recording the session's information) in the system. The flow also shows the applicable methodology of the utilization of data for data analysis.

### DETAILED DESCRIPTION OF PREFERRED EMBODIMENTS

The following is the configuration of the data analytic related contents contained in the presented invention:
1. The construction of a system with multiple validation operations (including the validation from the trusted third party) to deliver the sufficient understanding and the mutual agreement amongst all parties involved in the entire supply and value chain of the waste treatment procedures (i.e., multiple validation processes issued under the authority of the blockchain system)
2. The end-user/operator who manufactures a vacuum packaged waste through the device distributed (components that come together with the device are briefly described in the FIG. 1.) may try cheating the system by putting something heavy (like stone or metal) inside of the package to get heavier value from his/her wastes. Therefore, this invention will apply multiple parameters to check and to monitor the components of the mixed wastes inside of the vacuum package. For the case in which such inappropriate operations/practices are used, a digital image analysis is utilized as one of the solutions applicable in this presented invention. The digital image analytic algorithm based “edge-computing operation” minimizes the size of the data to increase the efficiency of data transmittal at the site of the operation in real-time. The major goal that must be achieved via the algorithm during edge-computing operation shall be “minimizing the size of the raw data”. To achieve this goal of minimizing the size of data, this invention transforms the original image data into a set of two-dimensional functions, f(x, y).

$$f ( x , y ) = ⌊ \begin{matrix}f ( 0 , 0 ) & f ( 0 , 1 ) & f ( 0 , 2 ) & ⋯ & f ( 0 , {N}_{y} - 1 ) \\ f ( 1 , 0 ) & f ( 1 , 1 ) & f ( 1 , 2 ) & ⋯ & f ( 1 , {N}_{y} - 1 ) \\ ⋯ & ⋯ & ⋯ & ⋯ & ⋯ \\ ⋯ & ⋯ & ⋯ & ⋯ & ⋯ \\ f ( {N}_{x} - 1 , 0 ) & f ( {N}_{x} - 1 , 1 ) & f ( {N}_{x} - 1 , 2 ) & ⋯ & f ( {N}_{x} - 1 , {N}_{y} - 1 )\end{matrix} ⌋$$

### Where:

x and y spatial coordinates
f(x, y) a set of G grey-tones & composition patterns of shape of the borderlines among mixed wastes.

### When:

x, y and the grey tones & shape of the borderlines of the mixed wastes of “f” have discrete quantities.

Digital images mainly deal with features such as, color, texture, and shape. Among those features, we selected “TEXTURE” as one of the major parameters to utilize for image recognition because the texture can be easily interpreted into smaller sizes of data than other parameters. This algorithm in edge-computing operation that deals with image analysis is one of the most important features in this invention for the purpose of the validation of the purity of the wastes in the package. The image's texture feature would also be interpreted into the pattern of structural information of an image and be the most important parameter for the operation of machine-learning and deep-learning in the later stages to reinforce the system.

The texture analysis in this presented invention has an important role in image processing and pattern recognition in order to validate and to confirm the purity of the wastes collected. To analyze the digital image captured by the optic sensor(s) attached to the device distributed to the end-user/operator, the operation of the texture related data extraction is the first step of analysis. The “Co-occurrence Matrix” method (the co-occurrence matrix is a statistical model that is useful in a variety of image analysis applications, such as in biomedical, remote sensing, industrial defect detection systems, etc.), and the Gabor method (Transformation method that represents an image in a space whose co-ordinate system has an interpretation that is closely related to the characteristics of a texture) are presented below as examples to explain how to extract the texture features and analyze it. These methodologies are commonly being utilized in commercial operation. In this invention, these methods involve transforming original images and calculating the energy of the images which are transformed.

$${I}_{{N}_{y} {H}^{( x , y )}} = {{\sum }_{i = 0}}^{{N}_{g} - 1} \frac{h ( i ) - {N}_{x} / G}{\sqrt{h ( i ) [ 1 - p ( i ) ] + {N}_{x} / {N}_{g} ( 1 - \frac{1}{{N}_{g}} )}}$$

### Where:

I Digital Image
i Discrete-value
Nₓ Number of pixel in the whole image
   where another supporting formulae must be prepared to confirm the coordinations of multiple pixels for connected linear shape objects.
   matrix A

$$\frac{d}{d α} ln \vert A \vert = Tr ( {A}^{- 1} \frac{d}{d α} A ) Tr ( {A}^{- 1} \frac{d}{d α} A ) = {\sum }_{i} \frac{{λ}_{i}^{′} ( α )}{{λ}_{i} ( α )} = {\sum }_{i} \frac{d}{d ( α )} ln {λ}_{i} ( α ) = \frac{d}{d α} {\sum }_{i} ln {λ}_{i} ( α ) = \frac{d}{d α} ln ( {\prod }_{i} {λ}_{i} ( α ) ) = \frac{d}{d α} ln \vert A \vert$$

N_{g} The number of gray levels in the image
H Entropy
h(i) Diagram which shows how many pixels of an image have a certain intensity
G Gray-level value
P(i) Probable density
α Optimal value
A Nonsingular symmetric matrix
Tr Trace of A

The Gabor Filters (linear filters) are commonly used in image analysis applications, and one of the methodologies that this invention could utilize via Gabor filters can also be utilized in the algorithm of edge-computing operation (especially for texture classification), texture segmentation, image recognition, and edge detection. The Gabor Filters is defined via the formula provided below:

$$g ( x , y , λ , δ , τ , ε , ζ ) = exp ( - \frac{x {φ}^{2} + {ζ}^{2} y {ω}^{2}}{2 {ε}^{2}} ) cos ( 2 π \frac{x φ}{λ} + τ )$$

### Where:

λ wavelength.
δ the orientation
τ the phase offset being applied after every calibration
ε sigma of the Gaussian envelope
φ x cos δ+y sin δ
ω −x sin δ+y cos δ
ζ spatial aspect ratio
3. After the basic analysis of the image file, which is briefly explained above, the sub algorithm based on the modeling of the 3D shapes from selected sets of multiple pixels of the mixed wastes are utilized to enhance the accuracy of the analysis. The major purpose of the application of this additional 3D shape modeling is to sort and/or screen the unexpected materials (such as stones, metals, and any foreign matters rather than the wastes expected). Through the practices of machine learning, any unexpected foreign matters (such as stones, metals, etc.) put into the mixed wastes shall be monitored at Point of Use (POU) in real-time. The specific information that includes the results of the analysis of each vacuum packaged waste shall be stored in the system and be shared via a digital barcode (such as QR Code) amongst the parties involved in the business practice throughout the entire supply and value chain.
4. To provide more explanation about the validation methodology applicable, this invention following example has been selected.
5. The 3D shape of the selected/targeted portion of the mixed waste is considered using an ellipsoid. The spheroid is a particular kind of ellipsoid that has at least two principal axes which have similar characteristics. Given the size of the selected portion of the mixed wastes and the typical distance between the lenses and the targeted objects, perspective effects can be considered as a negligible factor. The parallel lenses can be utilized from multiple angles inside of the device to focus on the same target for each selected portions of the mixed wastes to build the 3D shape. In this section, it is assumed that each binary mask from each lens located at different angles indicates which pixels correspond to the same selected portion of mixed wastes for each 3D view.
6. In practice, since the light conditions inside of the device are well controlled, the mask can be easily obtained by appropriately thresholding in the HSI color model (hue (H), saturation(S), intensity (I)). Given a binary mask, the algorithm starts functioning to obtain the length of the major axes of the ellipse and uses these values from all the available views from all selected portions of mixed wastes. It is then possible to infer the length of the major axes of the spheroid. Finally, the compiling process (fitting procedures) ends by calculating the elevation angle together with the 3D coordinates of all the pixels.
7. Given a selected 2D axis-oriented ellipse shape, it is possible to relate the variances of its pixel coordinates to the lengths of the radius. The covariance matrix Σ can be estimated by following expressions:

$${ES}_{x} = {\sum }_{p = 1}^{N} {x}_{p} , {ES}_{y} = {\sum }_{p = 1}^{N} {y}_{p} , {ES}_{xx} = {\sum }_{p = 1}^{N} {x}_{p}^{2} , {ES}_{yy} = {\sum }_{p = 1}^{N} {y}_{p}^{2} , {ES}_{xy} = {\sum }_{p = 1}^{N} {x}_{p} {y}_{p}$$

### Where:

(xₚ, yₚ) coordinates of a pixel under the mask for spheroid model
N the total number of pixels
Then, the variances and center of each selected portion of mixed waste is estimated from the previous sums as:

$${EO}_{x} = {ES}_{x} / N , {EO}_{y} = {ES}_{y} / N$$

$${σ}_{x}^{2} = \frac{{ES}_{xx}}{N} - {EO}_{x}^{2} , {σ}_{y}^{2} = \frac{{ES}_{y y}}{N} - {EO}_{y}^{2} , {σ}_{xy} = \frac{{ES}_{xy}}{N} - {EO}_{x} {EO}_{y}$$

where:
EOₓ, EO_{y} coordinate of each object center
ESₓ, ES_{y} coordinate of each spheroid model
N the total number of pixels
σₓ, σ_{y}, σ_{xy} 2D elliptical uniform distribution for the pixel coordinates
Modeling the 3D shape of the selected pixels (objects) from the mixed wastes that are collected by the end-users who operate the device to sort, dewater, and vacuum package the wastes in this presented invention is approximated based on the application of the ellipsoid that deals with a spheroid that has multiple major axes. Depending on the length of the axes, the ellipsoid can be differentiated as oblate or prolate. The radius of the sphere of the selected/targeted portion of the mixed wastes is obtained by applying the mean of the semi-major and semi-minor core axes from multiple directions of the views. The above explained 3D modeling will become the core algorithm for machine learning to speed up the operational time consumed for the validation processes.

$$α = β = \frac{1}{{N}_{v}} {\sum }_{i = 1}^{{N}_{ν}} \frac{{a}_{i} + {b}_{i}}{2}$$

### Where,

α=β it means that spheroid major axes are identical
aᵢ, bᵢ semi-major & semi-minor axes of the i^{th} view

$$β = {min}_{i} {b}_{i} α = \frac{1}{{N}_{ν}} {\sum }_{i = 1}^{{N}_{ν}} {α}_{i}$$

Now, the length of the equal semi-principal axes of the spheroid is β. The longest major axis of each spheroid object which is selected from the portion of mixed wastes will be observable only if it is orthogonal to the optic lens axis in at least one view. The major axes of the ellipsoid are calculated via:

$$α = {max}_{i} {α}_{i} β = \frac{1}{{N}_{ν}} {\sum }_{i = 1}^{{N}_{ν}} {b}_{i}$$

Elevation angle estimation. The goal of operation of the elevation angle estimation is to obtain the orientation of the 3D spheroid relative to the lens axis for non-spheric object (selected pixels from the portion of the mixed wastes). Consider a selected/targeted image data of an oblate object; the x- and y-axis will correspond to the image axes. A cross-section of a portion of the selected mixed wastes as an example in FIG. 7. through the 3D plane v1=0, we easily notice that the axes are v₂ and z and allow for the visualization of the principal spheroid axes.

Calculating the variance on each side, the algorithm obtains the relations and the following relation keeps:

$${b}^{2} = {A}^{2} {cos}^{2} θ + {B}^{2} {sin}^{2} θ = {A}^{2} {cos}^{2} θ + {B}^{2} ( 1 - {cos}^{2} θ )$$

### Where:

considering the relation between axes and variances from all 2D sides via continuous sets of lenses;

$${V}_{2} = {V}_{a} cos θ - {V}_{b} sin θ , {λ}_{2} = {σ}_{A}^{2} {cos}^{2} θ + {σ}_{B}^{2} {sin}^{2} θ$$

z-axis normal to the image.
v₁-axis oriented as the eigenvector.
λ₁ major eigenvalue
v₂-axis orthogonal to v1 and corresponds to the direction of the eigenvector.
λ₂ minor eigenvalue
θ the elevation angle (the angle between the Vₐ axis and the camera plane)
   angle θ can be isolated as

$$cos θ = \sqrt{\frac{{b}^{2} - {B}^{2}}{{A}^{2} - {B}^{2}}}$$

The rows of A pose matrix are the coordinates of the spheroid major axes in the lens frame
   the elements of this pose can be calculated from the eigenvectors of the 2D covariance matrix of the projected ellipse in each view & each elevation angle θ
   it is required to compute the elevation angle and the first row of the pose is the unit vector in the direction Vb
   the semi-axis length A be chosen aligned to V1
2b the length of the observed minor axis on the image
(A and B) spheroid dimensions

In order to estimate 3D rotations, the height “z” of every pixel from selected portions of the mixed wastes is required. The spherical model is not sophisticated, and therefore the data being generated via multiple sets of continuous optic sensors (including lens-less camera) will be processed via:

$$z = \sqrt{{A}^{2} - {( x - {CE}_{x} )}^{2} - {( y - {CE}_{y} )}^{2}}$$

### Where

A radius of the sphere
(x,y) the z-coordinate of pixel at image position
(CEₓ, CE_{y}) the center of the projected ellipse
   An equation of an axis-aligned oblate spheroid could be described as:

$${( \frac{x}{B} )}^{2} + {( \frac{y}{A} )}^{2} + {( \frac{z}{A} )}^{2} = 1$$

### Where

A & B lengths of the semi-major axes (A>B), or, equivalently, in matrix form as:

$${x}^{T} ⌊ \begin{matrix}\frac{1}{{B}^{2}} & 0 & 0 \\ 0 & 1 / {A}^{2} & 0 \\ 0 & 0 & 1 / {A}^{2}\end{matrix} ⌋ x = 1$$

Where
   x^{T} (x, y, z)
      The spheroid axes are not aligned with respect to each lens axes, so this patent introduces a Pose-Matrix as one of the examples to explain the concept of the basic components to deal with targeted/selected image recognition in the edge computing algorithm. The algorithm includes the calculation of the estimation of the multiple consecutive views (images) of the selected portion (targeted view) of the mixed wastes to rotate the matrix image to transform it into the 3D coordinates for a further matrix.

The goal of image pre-processing and analytics are to obtain reliable smaller images for machine learning based A.I. algorithms. A high pass filtering methodology has been utilized to minimize the number of multiple color channels, and this invention selects the green component to minimize the resolution of the image in targeted pixels. This dataset was originally intended to train machine learning models to recognize mixed wastes from multiple view angles. The use of a small set of points instead of all the points is meant to boost the processing speed. The Rotate 3D dataset can freely be utilized for further prospective algorithms in the closed system. All the procedures, including 2-D Geometry, Pose Modeling, and Rotation Estimation, can be done in less than 0.1 seconds.

Near-infrared spectroscopy is considered as a fast and non-destructive analytical tool, and machine learning carries an important role in the analysis of the spectral data to deal with Principal Component Analysis, Partial Squares-Discriminant Analysis for each component in the mixed wastes. This can then be applied for the classification and the heating-value calculation. The analysis of the components in the mixed wastes is extremely important to build up the mutual understanding for profit sharing. The attempt to minimize the size of the analytical application and optimize the size of analytical data and its acquisition time throughout the entire analytical procedures are critical requirements of analytical chemistry, especially in green analytical chemistry. This green analytical chemistry has contributed to the rapid development of a new generation of miniaturized near-infrared spectroscopy (NIR) spectrometric systems. The reason why we applied NIR spectroscopy instruments is to achieve a rapid, simple, and low-cost quantitative determination of the contents in the vacuum packaged mixed waste. Various types of composition of the solid wastes (especially food wastes) have been chosen, covering the maximum range of variability in lipid, protein, carbohydrate, fiber, and mineral content, and multivariate calibration was applied to correlate the recorded spectra with the macronutrient content of the packaged mixed wastes. During the procedure of NIR spectroscopy, the reflexed light scattering in the mixed wastes and the characteristics of the spectroscopic signals are controlled and utilized to gain more solid validation regarding the heating values in the fat, calcium, fiber, and protein content from the wastes that will become more solid. Therefore, the validation of the quality of the components in the vacuum-packed mixed wastes must be confirmed and reconfirmed amongst the parties involved in the business operation. Methodologies mentioned above, (the image analysis and the estimation of the heating value of the vacuum packaged waste via NIR spectroscopy) can be applied prior to starting the waste treatment procedure in the waste treatment factory. Patterns of the image (especially the shape of targeted object in the selected pixel) captured and being monitored in the targeted pixels can be described by multiple biometric parameters, which are closely associated with the weight of the component. Prior to the physical process of the waste treatment, this additional validation procedure via NIR spectroscopy can be applied at any point throughout the entire logistic steps. The above-mentioned validation processes to confirm the heating value from the wastes which are vacuum packaged are hired to calculate and to reconfirm the accuracy of calculation via the correlations among selected parameters such as, weights, textures, and humidity condition related data being generated via the spectroscopy. A practical allocation of the ubiquitous sensing across the energy related industries, especially the biomass-to-energy conversion chain has been considered and applied. The low-cost spectrometers, including a software that digests edge-node computing for data collection, model application, the transferring of data amongst different spectrometers, and calibration of the system are considered in real-time at POU. A practical software that receives data (including the NIR spectra) generated by the sensor (including spectrometer) which are equipped to the device in the very edge node and/or the one in the second edge node (such as collecting bin) via clouding platform processes it to generate the prediction model in the Business Rule Engine. This software relies on NIR spectroscopy to use the “collect-calibrate-predict” process based on the partial least squares algorithms and the data being produced by this methodology is utilized for further machine learning (ML) algorithms. This validation procedure and services to confirm and reconfirm the purity of the waste can be provided by subsidiary system and/or by the trusted third-party system.

Carbon Credit related Monitoring, Report, Validating (M.R.V.) and accreditation services/calculations that can be considered from the operation of this presented invention shall also be provided via subsidiary system and/or by the trusted third-party's system.
8. Common information attached with tags. Since the vacuum packaged waste travels from the restaurant to collecting bin, and then from collecting bin to truck for truck to deliver it to the waste treatment factory, the very first data that includes the information of the restaurant, waste type, preliminary data for expected heating value (we call it common data attached with tags) shall travel with that vacuum packaged waste throughout the entire supply chain until it is physically and chemically separated by the pyrolysis procedure. This common information must be attached with tags because more data will be added to this tag while vacuum package travels all the way to the waste treatment plant
9. Routing system that receives and generates network addresses
10. Systems that store the correlation between the processed data and the account information

The methodology of the data-management introduced in the present invention is applied to the wastes (especially the food wastes) generated by the farm, the packing house, the manufacturing site, the general retail stores and/or the common household. This methodology also includes a waste treatment-related financial payment system that has multiple verification and validation procedures for the fair profit distribution amongst the parties involved. The specific data collected and stored in the first layer data-folder is constituted of the unique signal containing basic information including the business name, address, date, and time of generation of the waste package as well as other general information about the packaged waste produced by the customer from time to time.

Additional data collected and stored in the second layer data-folder is related to specific parameters (such as the percentage of the moisture inside of the vacuum packaged waste, weight of each package, and forecasted heating value of each vacuumed package waste) that are monitored at the Point of Use (POU). The raw data generated and stored in the first and second layers are transmitted via unique signals to the routing system. The system then responds to the signal to determine whether the received signal is acceptable or not for further steps, which includes the application of the algorithm for measuring the value of the waste for the payment system.

All data being generated through the entire process of the waste-treatment are stored in the third layer of the data folder. The third step includes the process of implementation based on the mutual understanding amongst all parties involved about the treatment of the waste for the fair distribution of the profits from the sales of products/byproducts.

The algorithm that deals with the profit distribution of the values of wastes treated also includes the calculation of carbon credit-related revenue. This additional task that is related to carbon-credit can be performed through the cooperation with and/or in conjunction with the institution's system, which provides already certified Carbon Emission MRV (Monitoring, Reporting, and Validation) related services.

This invention also includes:
1. A system with multiple layers of validations (including validations from the trusted third parties)
2. The application of block-chain to ensure the transparency and efficiency of operation for the validations
3. The application of the specific common information to apply all validations
4. The decentralized routing system that receives and generates network addresses
5. A routing system that responds to received signals from all decentralized validation nodes
6. A routing system that uses multiple wide-range communication links for the main algorithm's data analytics
7. An account for irrelevant or unfamiliar data

The methods introduced in the present invention are steps applied to the general retail store and/or the common household. The first of the specific information constituting the individual unique signal is related to the processing of basic information (business name, address, date, and time of generation of the waste package as well as general information about the waste produced by the customer). All data in this phase are stored in the first layer of the data folder and the following steps deal with data that is related to the transmittal and receiving of processed data:
1) Pushing the first generated individualized unique signal to the cloud
2) The procedure of responding to the signal pushed to the cloud to determine whether the first signal can be linked to the payment system or not
3) The approved signal for the payment system opens the second layer of the data folder to determine whether to apply the algorithm for measuring the value of the packaged waste or not

The parties who have participated in the waste treatment system presented in this invention have a mutual understanding of the entire process for the distribution of values evaluated by the algorithm and the execution of the distribution. The steps of the algorithms for the fair distribution of profits from the value of the treated waste among all parties participating in the specific treatment include:
1) The step for the monitoring and validating of the “STATUS” of the targeted vacuum packaged waste. The parameters supporting the “STATUS” of the targeted vacuum packaged waste include:
   a. The percentage of moisture
   b. The weight of the package
   c. The data of the major components of the wastes in the package
This specific data that deals with the information of the various components in the packaged waste is calculated based on the general information stored in the first layer of the data folder. Data from these three parameters are stored in the second layer of the data folder.
2) In disposing of the waste in the algorithm, the calculation of carbon emission-related revenue allocation among the parties involved can be performed in cooperation with and/or in conjunction with the institution's system, which provides already certified Carbon Emission MRV (Monitoring, Reporting, and Validation) related services.

1. A novel idea that guarantees transparency of the proper and fair profit distribution amongst the parties involved via multi-layer validation together with block-chain technology, which ultimately results in the sharing of financial profits with the original owner of the wastes (the party that generates the waste).

2. A Smart Waste Sorting and Packaging Device that packages wastes (especially vacuum packaging the food wastes) at the harvesting site, the packing house (warehouse), the manufacturing facility, the retail store, the household, and even the portable kitchen (cooking unit) used by street food vendors for the traceability and transparency of all transactions dealing with waste treatment throughout the entire value and supply chains to share the financial benefits amongst all parties involved.

3. The application of AIoT technology to the packaging device according to claim 2.

4. The application of devices to the packaging device according to claim 2 to generate and to print a matrix barcode (such as QR code) on the surface of the packaged wastes (especially the vacuum packaged food wastes).

5. The application of monitoring devices (various types of sensors, including the one for NIR spectroscopy) to the packaging device according to claim 2 to sense multiple parameters (such as the status of the humidity, weight, forecasted heating value, and customer's information) of the packaged wastes (especially the vacuum packaged food wastes).

6. Saving the data from the multiple parameters monitored by the sensors according to claim 4 as well as customer's information regarding the packaged wastes in the matrix barcode (such as QR code).

7. The use of multi-layer validations.

8. The use of edge-node computing (including the transformation of image data into 2D coordination data) for image analysis (such as image recognition and extraction) of the collected mixed wastes in order to allow for validation according to claim 7.

9. The use of NIR spectroscopy to monitor the status of the components of the mixed wastes in the vacuum package and to calculate the heating value of the non-destructive vacuum packaged mixed wastes in order to allow for validation according to claim 7.

10. The use of the correlation of parameters (such as weight, color, viscosity, texture characteristics, etc.) selected from the various types of sensors applied (such as the optics sensor for image analysis and the sensors for NIR spectroscopy) in order to allow for validation according to claim 7.

11. Applying block-chain technology for each node where any activity related with the wastes occurs (such as when the wastes are collected, when the wastes are sorted and packaged, when the packaged wastes are stored (for example, the waste collecting bins located at designated spots in the community), and every phase where the specific operation during the procedure of the business flow contributes to carbon emission reduction), when the condition of the packaged wastes are monitored by the third party, when the packaged wastes are delivered to the designated waste-treatment plant, and when the packaged wastes are fully treated) throughout the entire value and supply chains of the waste-treatment system to guarantee the transparency according to claim 1.

12. Applying the IoT device & software applications (such as the mobile phone, software applications (including Carbon Emission M.R.V.) that provide pinpad-like user interface) to create a user-friendly interface for the Point-of-Transaction (POT) devices in order to guide the client/person/operator to properly perform the specific tasks/operations, as required by the manual, in each specific node that deals with the pushing and receiving of that contains the status of the targeted packaged wastes (such as, status of the process, the heating value of the specific package, and forecasted economic value of the package) so that the information is fully disclosed to all parties involved in order to guarantee transparency according to claim 1.

13. Applying the physical proprietary radio communication that functions based on spread-spectrum modulation techniques together with a related software communication system architecture (such as the LoRa WAN) in order to push data generated from the sensors throughout the entire value/supply chains of the waste-treatment to guarantee the transparency according to claim 1.

14. Adding the client who makes the packaged wastes (i.e. the party that generates the wastes) to the list of beneficiaries for profit distributions that result from the gains of waste-treatment in order to properly share profits according to claim 1.

15. A payment method that involves operating an IoT device application server that directly and indirectly communicates with at least one Point-of-Transaction (POT) device via the data being generated and computed in the system to confirm and reconfirm the value of the wastes in order to properly share profits according to claim 1.

16. A payment method that involves the receiving and sending of data, which is performed by the application operating server based on the digital image analytic algorithm, the block-chain technology applied algorithm, and the NIR spectra analytic algorithm all in order to be able to properly share profits according to claim 1.

17. The use of a pinpad-like user interface (such as the one shown via FIG. 8) to receive data from the users who enter information into an operator-side IoT device application server.

18. The generation of a temporary token, after receiving proper verification data of the operator, that is displayed on the operator's IoT device according to claim 17.

19. The identification of the operator associated with the Point-of-Transaction (POT) gathered from the operator's IoT device according to claim 17 and further confirming the data on each transaction for the identified customer via a block-chain technology applied system.

20. The algorithm for the payment method that is comprised of a step performed by an algorithm to treat a temporary token as expired after a predetermined period.

21. The methodology used for the distribution of the physical devices (units to treat the wastes) without any financial installment being charged to the recipients upon said distribution.

22. The algorithm for the repayment method for the physical devices distributed according to claim 21, where the cost of the device is covered without the direct payment from the operator/clients/household but instead from the results of recycling their wastes.
